(19) United States
(12) Patent Application Publication
(10) Pub. No.: US 2018/0019063 A1
(43) Pub. Date: Jan. 18, 2018

(54) FILM CAPACITOR

(71) Applicant: SAMSUNG ELECTRO-MECHANICS CO., LTD., Suwon-si (KR)

(72) Inventors: Young Ghyu AHN, Suwon-si (KR); Byoung Hwa LEE, Suwon-si (KR)

(21) Appl. No.: 15/467,364

(22) Filed: Mar. 23, 2017

(30) Foreign Application Priority Data
Jul. 13, 2016 (KR) 10-2016-0088777

(51) Int. Cl. H01G 4/33; H01G 4/012; H01G 4/12

(52) U.S. Cl. CPC H01G 4/33; H01G 4/1245; H01G 4/012; H01G 4/1227

(57) ABSTRACT

A film capacitor includes a capacitor body including a dielectric film and first and second internal electrodes, and first and second external electrodes disposed on the capacitor body and connected to the first and second internal electrodes, respectively. The dielectric film includes a base film formed of an insulating inorganic compound particle and a resin and high-k powder having permittivity higher than that of the base film. The high-k powder is dispersed in the base film.

### CROSS-REFERENCE TO RELATED APPLICATION(S)

This application claims benefit of priority to Korean Patent Application No. 10-2016-0088777, filed on Jul. 13, 2016 in the Korean Intellectual Property Office, the disclosure of which is incorporated herein by reference in its entirety.

### TECHNICAL FIELD

The present disclosure relates to a film capacitor.

### BACKGROUND

Recently, industrial devices used in networks, or the like, increasingly use high voltages for high output performance. In addition, as hybrid cars or electric cars have become more prevalent, demand for capacitors having a high voltage and high reliability has also grown.

Among capacitors having a high voltage and high reliability is a film capacitor. The film capacitor is a capacitor using a film formed of polypropylene (PP), or the like, as a dielectric material, having characteristics of realizing high reliability by repairing internal defects, using a self-healing function, based on a thin internal electrode and a PP resin.

However, the film of the related art film capacitor only has a permittivity of a level of 2 to 3, namely, very small. Due to this, the capacitor is relatively increased in size and vulnerable to heat. The increase in size of the capacitor increases cost, thus a surface-mounted device (SMD) is costly.

### SUMMARY

An aspect of the present disclosure may provide a film capacitor which is miniaturized by increasing capacity of a product, while ensuring reliability through a self-healing function.

According to an aspect of the present disclosure, a film capacitor may include: a capacitor body including a dielectric film and first and second internal electrodes; and first and second external electrodes disposed on the capacitor body and respectively connected to the first and second internal electrodes. The dielectric film includes a base film formed of an insulating inorganic compound particle and a resin, and high-k powder having permittivity higher than that of the base film and dispersed in the based film.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a film capacitor according to a first exemplary embodiment in the present disclosure;

FIG. 2 is a cross-sectional view taken along line I-I′ of FIG. 1;

FIG. 3 is a cross-sectional view schematically illustrating a film capacitor according to a second exemplary embodiment in the present disclosure; and

FIG. 4 is a cross-sectional view schematically illustrating a film capacitor according to a third exemplary embodiment in the present disclosure.

### DETAILED DESCRIPTION

Exemplary embodiments in the present disclosure will now be described in detail with reference to the accompanying drawings.

As for the directions of a capacitor body, to clarify exemplary embodiments in the present disclosure, X, Y, and Z shown in the drawings represent a length direction, a width direction, and a thickness direction, respectively. Here, the term ‘thickness direction’ may be used as having the same concept as a stacking direction of a dielectric film and an internal electrode.

Also, in the present exemplary embodiment, for purposes of description, both surfaces of a capacitor body 110, opposing each other in the Z direction, are set to first and second surfaces S1 and S2, both surfaces opposing each other in the X direction and connecting front ends of the first and second surfaces S1 and S2 are set to third and fourth surfaces S3 and S4, and both surfaces opposing each other in the Y direction and connecting front ends of the first and second surfaces S1 and S2 and the third and fourth surfaces S3 and S4 are set to fifth and sixth surfaces S5 and S6. Here, the ‘first surface S1’ may be used as having the same concept as that of amounting surface.

Film Capacitor

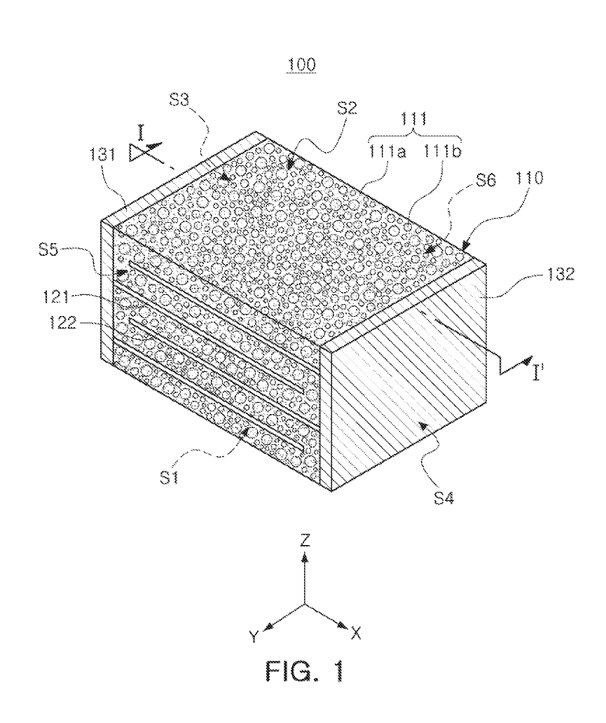

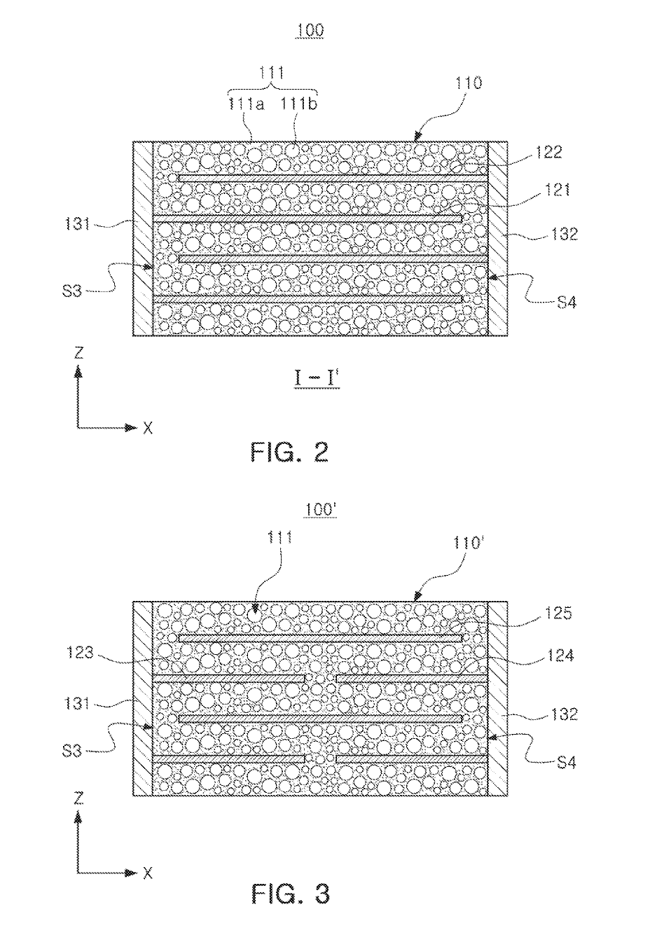

FIG. 1 is a perspective view schematically illustrating a film capacitor according to a first exemplary embodiment in the present disclosure, and FIG. 2 is a cross-sectional view taken along line I-I′ of FIG. 1.

Referring to FIGS. 1 and 2, a film capacitor according to the first exemplary embodiment in the present disclosure includes a capacitor body 110 including a dielectric film 111 and first and second internal electrodes 121 and 122, and first and second external electrodes 131 and 132.

The capacitor body 110 may be formed by stacking a plurality of dielectric films 111 and may substantially have a hexahedral shape, as illustrated, but is not limited thereto. Here, a shape and dimensions of the capacitor body 110 and the stacking number of the dielectric film 111 are not limited to those illustrated in the drawing.

The dielectric film 111 includes a base film 111a formed of insulating inorganic compound particles and a resin and high-k powder 111b. The High-k powder 111b is evenly distributed within the base film 111a and has permittivity higher than that of the base film 111a. Here, a thickness of the dielectric film 111 may be changed according to a design of the film capacitor 100.

The inorganic compound particles may include an inorganic oxide such as a ceramic, alumina, a titanium oxide, a silicon oxide, and the like, or an inorganic nitride such as a silicon nitride, glass, and the like.

Here, the resin of the base film 111a may be polypropylene (PP) and the high-k powder 111b may be either barium titanate (BT) or CSZT but is not limited thereto. For example, the resin may be polyethylene terephthalate (PET), polyphenylenesulfide (PPS), a cycloolefinepolymer (COP), and the like.

A filling rate of the high-k powder 111b may be 21% or greater against the base film 111a. Since the base film 111a has permittivity of about 2 to 3, when a dielectric film is manufactured by filling the high-k powder 111b having permittivity of about 100 by 21% or greater against the base film 111a on the basis of volume, capacitance of a capacitor may be increased by about 4.8 times.

The first and second internal electrodes 121 and 122 have different polarities. The first and second internal electrodes 121 and 122 are disposed alternately, with the dielectric film 111 interposed therebetween within the capacitor body 110 in the Z direction.

The first and second internal electrodes 121 and 122 are formed to be exposed to the third and fourth surfaces S3 and S4 of the capacitor body 110, respectively, and an area in which the first and second internal electrodes 121 and 122 overlap each other in the Z direction is related to formation of capacitance of the capacitor.

The first and second internal electrodes 121 and 122 are metal films of aluminum (Al), copper (Cu), silver (Ag), and the like, formed on the dielectric film 111 through deposition. Here, a thickness of each of the first and second internal electrodes 121 and 122 is preferably 30 nm or less.

The first and second external electrodes 131 and 132 are formed on the third and fourth surfaces S3 and S4 and are in contact with and electrically connected to exposed portions of the first and second internal electrodes 121 and 122, respectively.

The first and second external electrodes 131 and 132 may be formed of conductive paste including a conductive metal. The conductive metal may be, for example, a nickel (Ni), copper (Cu), palladium (Pd), gold (Au), or an alloy thereof, but is not limited thereto.

The first and second external electrodes 131 and 132 may be formed through sputtering, for example, but is not limited thereto.

The first and second internal electrodes 121 and 122 of the present exemplary embodiment may have a thickness of 30 nm or less. Thus, when an insulation-defective portion of the dielectric film 111 is shorted, the base film 111a of the dielectric film 111 near the defective portion is melted by heat generated due to the short, to cause the first and second internal electrodes 121 and 122 to be separated from each other, thus intercepting dielectric breakdown of the capacitor to prevent ignition or an electric shock accident. This is called self-healing.

The film capacitor 100 according to the present exemplary embodiment may have properties of a highly reliable capacitor by healing internal defects of the capacitor body through self-healing through application of a high voltage before a product is released.

Also, since the high-k powder 111b having permittivity higher than that of the base film 111a is added to the dielectric film 111, overall permittivity may be increased, to increase capacitance of the capacitor, while maintaining the self-healing function, based on the thin internal electrodes 121 and 122 and the base film 111a as is. The film capacitor 100 may be applied as a high voltage and highly reliable capacitor of industrial devices and electric/electronic devices, for example.

### Experimental Example

Hereinafter, a method for manufacturing the film capacitor according to the present exemplary embodiment will be described.

First, a polypropylene resin is dissolved in a solvent to form a base film. In detail, high-k powder having permittivity higher than that of a base film is added to the polypropylene resin to prepare a slurry, and the slurry is cast in the form of a thin sheet to prepare first and second dielectric films.

Next, a metal component is deposited on one surface of each of the first and second dielectric films, to form thin first and second internal electrodes having a predetermined pattern.

Thereafter, a plurality of first and second dielectric films with the first and second internal electrodes formed thereon are alternately stacked and compressed to form a bar-shaped stacked body (or a laminate).

Then the stacked body is cut in every region corresponding to each film capacitor to form a chip. First and second external electrodes are formed on the capacitor body such that the first and second external electrodes are connected to exposed portions of the first and second internal electrodes through sputtering, thus manufacturing an SMD-type film capacitor.

In an experiment carried out by the inventor, in manufacturing the first and second dielectric films the contents of high-k powder versus films were differentiated by samples, and an increase in capacitance and self-healing of completed film capacitors of the respective samples was measured. Table 1 below shows the measurement results.

Here, an increase in capacitance was determined to be 10%, when measuring variations of capacitance of the capacitors, and self-healing was determined on the basis of whether a short occurred and through detecting a change in capacitance after applying a high voltage to the capacitors.

TABLE 1

| | Addition | | | | | |
|---|---|---|---|---|---|---|
| | of | | | Capacitance | | |
| | High-k | Permittivity | | of | Increase | |
| | dielectric | of | Filling rate | capacitor | in | |
| No. | powder | powder | (vol %) | (nF) | capacitance | Self-healing |
| 1 | X | — | — | 1.0 | — | OK |
| 2 | ◯ | 10 | 14 | 1.1 | NG | OK |
| 3 | ◯ | 10 | 21 | 1.2 | OK | OK |
| 4 | ◯ | 10 | 30 | 1.4 | OK | OK |
| 5 | ◯ | 10 | 61 | 2.2 | OK | OK |
| 6 | ◯ | 10 | 77 | 3.2 | OK | OK |
| 7 | ◯ | 10 | 88 | 4.7 | OK | OK |
| 8 | ◯ | 100 | 14 | 1.2 | OK | OK |
| 9 | ◯ | 100 | 21 | 1.3 | OK | OK |
| 10 | ◯ | 100 | 31 | 1.5 | OK | OK |
| 11 | ◯ | 100 | 60 | 2.4 | OK | OK |
| 12 | ◯ | 100 | 75 | 3.9 | OK | OK |
| 13 | ◯ | 100 | 85 | 6.3 | OK | OK |

Sample 1 is a conventional comparative example without high-k powder, to which the results of samples 2 to 13 are compared. Referring to Table 1, it can be seen that the self-healing function was obtained regardless of whether high-k powder was added or not, which means that high-k powder did not affect the self-healing function.

Further, since samples 2 and 8, in which a filling rate of high-k powder was 14%, had a variation of capacitance of less than 10%, they were determined to be ineffective in determining an increase in capacitance. In contrast, samples 3 to 7 and 9 to 13, in which a filling rate of high-k powder was 21% or greater, had a rate of increase in capacitance of 10% or greater such that it was determined that an increase in capacitance had occurred, and denoting that a meaningful increase in capacitance had been achieved. That is, in order to obtain a meaningful increase in capacitance, a filling rate of high-k powder is required to be 21% or greater as compared to a base film without high-k powder dispersed therein.

Meanwhile, when capacitance of the capacitors of samples 3 to 7, in which permittivity of high-k powder was 10, and capacitance of the capacitors of samples 9 to 13, in which permittivity of high-k powder was 100, are compared, it can be seen that an increase in capacitance of samples 9 to 13 is higher, but it can be noted that an increase in capacitance of the capacitors is more affected by the filling rate than by the permittivity of the high-k powder included in the dielectric films, when the degree of increase is considered.

Therefore, when capacitance of a capacitor is intended to be increased by increasing either the permittivity or the filling rate of high-k powder, increasing the filling rate of the high-k powder, rather than increasing the permittivity of the high-k powder, may have priority.

### Modified Example

FIG. 3 is a cross-sectional view schematically illustrating a film capacitor according to a second exemplary embodiment in the present disclosure.

Here, structures of the dielectric film 111 and first and second external electrodes 131 and 132 are similar to those of the exemplary embodiment described above, thus redundant descriptions thereof will be omitted.

Referring to FIG. 3, a film capacitor 100′ of the present exemplary embodiment further includes a floating electrode 125. In addition, the first and second internal electrodes 123 and 124 are disposed to be spaced apart from each other in the X direction on any one dielectric film 111.

The first internal electrode 123 is exposed to the third surface S3 of the capacitor body 110′ in the X direction, and an exposed portion thereof is connected to the first external electrode 131, disposed on the third surface S3 of the capacitor body 110′. Here, a length of the first internal electrode 123 is less than ½ of a length of the capacitor body 110′.

The second internal electrode 124 is exposed to the fourth surface S4 of the capacitor body 110′ in the X direction, and an exposed portion thereof is connected to the second external electrode 132, disposed on the fourth surface S4 of the capacitor body 110′. Here, a length of the second internal electrode 124 is less than ½ of a length of the capacitor body 110′.

The floating electrodes 125 are disposed alternately with the first and second internal electrodes 123 and 124, with the dielectric film 111 interposed therebetween in the Z direction. The floating electrodes 125 are spaced apart from the first and second external electrodes 131 and 132 in the X direction and positioned within the capacitor body 110′. The floating electrodes 125 are disposed to overlap portions of the first and second internal electrodes 123 and 124, to form capacitance of the capacitor.

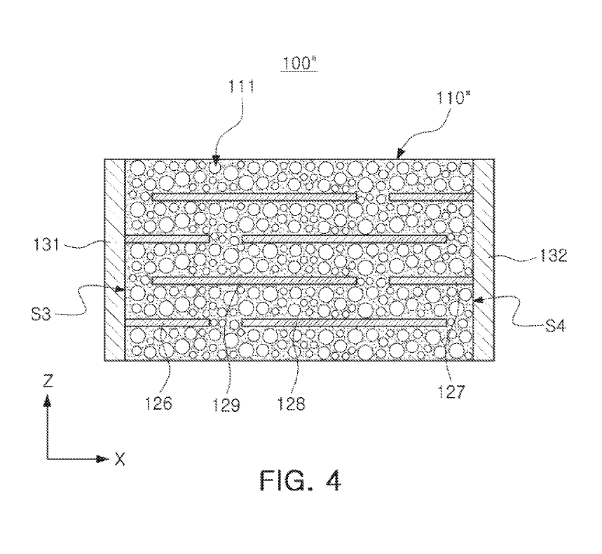

FIG. 4 is a cross-sectional view schematically illustrating a film capacitor according to a third exemplary embodiment in the present disclosure.

Here, structures of the dielectric film 111 and first and second external electrodes 131 and 132 are similar to those of the first exemplary embodiment described above, thus redundant descriptions thereof will be omitted.

Referring to FIG. 4, a film capacitor 100″ of the present exemplary embodiment further includes first and second floating electrodes 128 and 129. Also, first and second internal electrodes 126 and 127 are disposed alternately in the Z direction with the dielectric film 111 interposed therebetween.

The first internal electrode 126 is exposed to the third surface S3 of the capacitor body 110″ in the X direction, and an exposed portion thereof is connected to the first external electrode 131 disposed on the third surface S3 of the capacitor body 110″. Here, a length of the first internal electrode 126 is preferably set to be less than ½ of a length of the capacitor body 110″.

The first floating electrode 128 is disposed on the dielectric film 111, on which the first internal electrode 126 is disposed. The first floating electrode 128 is spaced apart from the first internal electrode 126 and the second external electrode 132 in the X direction and positioned within the capacitor body 110″.

The first floating electrode 128 is disposed to overlap portions of the second internal electrode 127 and the second floating electrode 129 in the Z direction, to form the capacitance of the capacitor. Here, a length of the first floating electrode 128 may be set to be greater than a length of the first internal electrode 126, and may be set to be ½ of a length of the capacitor body 110″ or greater, to increase an overlapping area with the second internal electrode 127 and the second floating electrode 129, in order to secure a higher capacitance of the capacitor.

The second internal electrode 127 is exposed to the fourth surface S4 of the capacitor body 110″ in the X direction, and an exposed portion thereof is connected to the second external electrode 132, disposed on the fourth surface S4 of the capacitor body 110″. Here, a length of the second internal electrode 127 is preferably set to be less than ½ of the length of the capacitor body 110″.

The second floating electrode 129 is disposed on the dielectric film 111, on which the second internal electrode 127 is disposed. The second floating electrode 129 is spaced apart from the second internal electrode 127 and the first external electrode 132 in the X direction and positioned within the capacitor body 110″.

The second floating electrode 129 is disposed to overlap portions of the first internal electrode 126 and the first floating electrode 128 in the Z direction to further form capacitance of the capacitor. Here, a length of the second floating electrode 129 may be set to be greater than a length of the second internal electrode 127, and may be set to be ½ of a length of the capacitor body 110″ or greater, to increase an overlapping area with the first internal electrode 127 and the first floating electrode 128, to further secure higher capacitance of the capacitor.

As set forth above, according to an exemplary embodiment in the present disclosure, since the capacitor body includes the thin internal electrodes and the dielectric films, when a short occurs, an internal defect is healed through a self-healing function, thus increasing reliability of the capacitor, and since the dielectric film includes the high-k powder having permittivity higher than that of the base film, to increase capacitance relative to an existing product, a size of the product may be reduced, compared to a product with the same capacitance.

While example embodiments have been shown and described above, it will be apparent to those skilled in the art that modifications and variations could be made without departing from the scope of the present invention, as defined by the appended claims.

What is claimed is:

1. A film capacitor comprising:
a capacitor body including a dielectric film and first and second internal electrodes; and
first and second external electrodes disposed on the capacitor body and connected to the first and second internal electrodes, respectively,
wherein the dielectric film includes a base film formed of an insulating inorganic compound particle and a resin, and high-k powder having permittivity higher than that of the base film and dispersed in the base film.

2. The film capacitor of claim 1, wherein a filling rate of the high-k powder is 21% or greater, compared with the base film in the dielectric film.

3. The film capacitor of claim 1, wherein the high-k powder is either barium titanate (BT) or CSZT.

4. The film capacitor of claim 1, wherein
the first and second internal electrodes are disposed alternately, with the dielectric film interposed therebetween and exposed to opposing surfaces of the capacitor body, and
the first and second external electrodes are disposed on opposing surfaces of the capacitor body and are in contact with exposed portions of the first and second internal electrodes, respectively.

5. The film capacitor of claim 1, wherein
the first and second internal electrodes are disposed to be spaced apart from each other by the dielectric film and exposed to opposing surfaces of the capacitor body,
the first and second external electrodes are disposed on opposing surfaces of the capacitor body and connected to the exposed portions of the first and second internal electrodes, respectively, and
a floating electrode disposed alternately with the first and second internal electrodes with another dielectric film interposed therebetween, spaced apart from the first and second external electrodes, and overlapping portions of the first and second internal electrodes.

6. The film capacitor of claim 1, wherein
the first and second internal electrodes are disposed alternately, with the dielectric film interposed therebetween and exposed to opposing surfaces of the capacitor body,
the first and second external electrodes are disposed on opposing surfaces of the capacitor body and connected to the exposed portions of the first and second internal electrodes, respectively, and
the film capacitor further comprising:
a first floating electrode disposed on another first dielectric film, on which the first internal electrode is disposed, spaced apart from the first internal electrode and the second external electrode, and overlapping a portion of the second internal electrode; and
a second floating electrode disposed on another second dielectric film, on which the second internal electrode is disposed, spaced apart from the second internal electrode and the first external electrode, and overlapping portions of the first internal electrode and the first floating electrode.
